(19) United States
(12) Patent Application Publication
(10) Pub. No.: US 2018/0118084 A1
(43) Pub. Date: May 3, 2018

(54) TURBINE BLADE DISPOSAL SYSTEM

(71) Applicant: Logisticus Projects Group, Greenville, SC (US)

(72) Inventors: Vikash Patel, Greenville, SC (US); Mihir Patel, Johns Island, SC (US); William Stephan, Clifton Park, NY (US); Phillip Mitchum, Houston, TX (US)

(21) Appl. No.: 15/431,019

(22) Filed: Feb. 13, 2017

Related U.S. Application Data
(60) Provisional application No. 62/413,759, filed on Oct. 27, 2016.

(51) Int. Cl. B60P 3/40; F03D 13/40

(52) U.S. Cl. CPC B60P 3/40; F05B 2260/02; F05B 2240/21; F03D 13/40

(57) ABSTRACT

A wind turbine blade has a disassembled condition defined by separated blade sections. Each blade section has a residual leading edge remaining from an original leading edge of the blade, a residual trailing edge remaining from an original trailing edge of the blade, and a residual length delimited by a severed edge of the blade. Blade support fixtures are configured for mounting on a transportation platform at spaced-apart locations. Each fixture has a plurality of blade-receiving seats, and each seat is configured with reference to a residual edge portion of a respective one of the separated blade sections.

### CROSS-REFERENCE TO RELATED APPLICATIONS

This application claims benefit of U.S. Provisional Patent Application No. 62/413,759, filed Oct. 27, 2016 which is incorporated by reference herein in its entirety.

### TECHNICAL FIELD

This technology relates to blades for wind turbines, and relates particularly to handling and transportation of turbine blades for disposal.

### BACKGROUND

A blade for a wind turbine is typically disposed of by cutting the blade into multiple sections for loading on a trailer bed in random orientations.

### SUMMARY

A turbine blade has a disassembled condition defined by separated blade sections. Each blade section has a residual leading edge remaining from an original leading edge of the blade, a residual trailing edge remaining from an original trailing edge of the blade, and a residual length delimited by a severed edge of the blade. Blade support fixtures are configured for mounting on a transportation platform at spaced-apart locations. The fixtures have blade-receiving seats configured with reference to residual edge portions of the separated blade sections.

### BRIEF DESCRIPTION OF THE DRAWINGS

FIG. 1 is a side view of a wind turbine blade.

FIG. 2 is a view of the blade in a disassembled condition.

FIG. 3 is an end view taken on line 3-3 of FIG. 2.

FIG. 4 is an end view taken on line 4-4 of FIG. 2.

FIG. 5 is an end view taken on line 5-5 of FIG. 2.

FIG. 6 is an end view taken on line 6-6 of FIG. 2.

FIG. 7 is an end view taken on line 7-7 of FIG. 2.

FIG. 8 is a sectional view taken on line 8-8 of FIG. 2.

FIG. 9 is a side view showing the disassembled blade of FIG. 2 on a trailer.

FIG. 10 is a top view of the trailer and disassembled blade of FIG. 9.

FIG. 11 is a partial sectional view taken on line 11-11 of FIG. 10.

FIG. 12 is a view taken on line 12-12 of FIG. 10.

### DETAILED DESCRIPTION

The structures illustrated in the drawings include examples of the elements recited in the claims. The illustrated structures thus include examples of how a person of ordinary skill in the art can make and use the claimed invention. These examples are described to meet the enablement and best mode requirements of the patent statute without imposing limitations that are not recited in the claims. Elements of one embodiment may be used in combination with, or as substitutes for, elements of another as needed for any particular implementation of the invention.

As shown in FIG. 1, a wind turbine blade 10 has a root 12 at one end, a tip 14 at the opposite end, and an intermediate shoulder 16. An airfoil portion 20 of the blade 10 reaches from the shoulder 16 to the tip 14. The airfoil portion 20 has a cross-sectional shape configured as an airfoil having a chord length between a leading edge 22 and a trailing edge 26. A root portion 28 of the blade 10 reaches from the shoulder 16 to the root 12, at which the blade 10 has a cylindrical shape with a circular array of mounting studs 30 for attaching the blade 10 to a rotor.

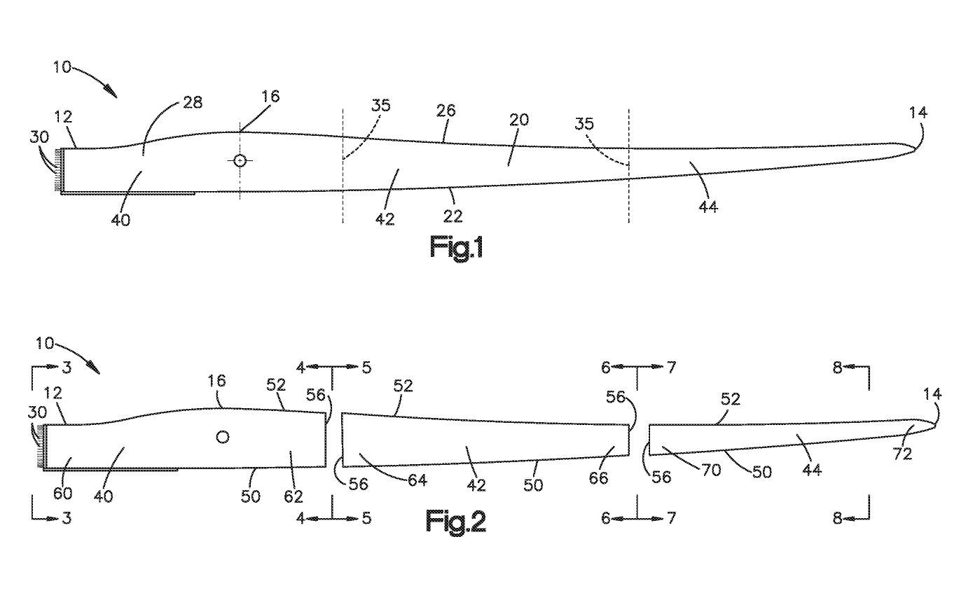

As further shown schematically in FIG. 1, a pair of cut lines 35 reach across the blade 10 to delineate three sections 40, 42 and 44 of equal or substantially equal length. The cut lines 35 define locations at which the blade 10 is to be cut into a disassembled condition defined by the three blade sections 40, 42 and 44 when separated as shown in FIG. 2. In that condition, each of the three separated blade sections 40, 42 and 44 has a residual leading edge 50 remaining from the original leading edge 22 of the blade 10, a residual trailing edge 52 remaining from the original trailing edge 26 of the blade 10, and a residual length delimited by a severed edge 56 of the blade 10.

More specifically, the separated sections 40, 42 and 44 of the blade 10 in the illustrated embodiment include a root section 40, an intermediate section 42, and a tip section 44. The root section 40 has a proximal end portion 60 including the root 12 of the blade 10. The root section 40 further has a distal end portion 62 ending at a severed edge 56 of the blade 10. The intermediate section 42 has a proximal end portion 64 beginning at a severed edge 56 of the blade 10, and has a distal end portion 66 ending at a severed edge 56 of the blade 10. The tip section 44 has a proximal end portion 70 beginning at a severed edge 56 of the blade 10, and has a distal end portion 72 including the tip 14 of the blade 10.

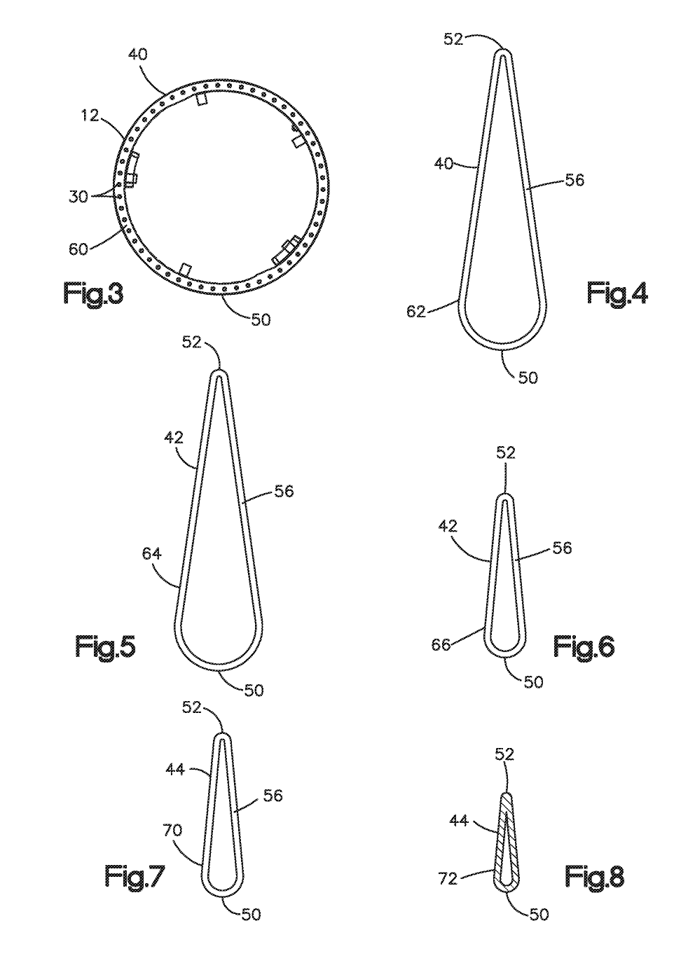

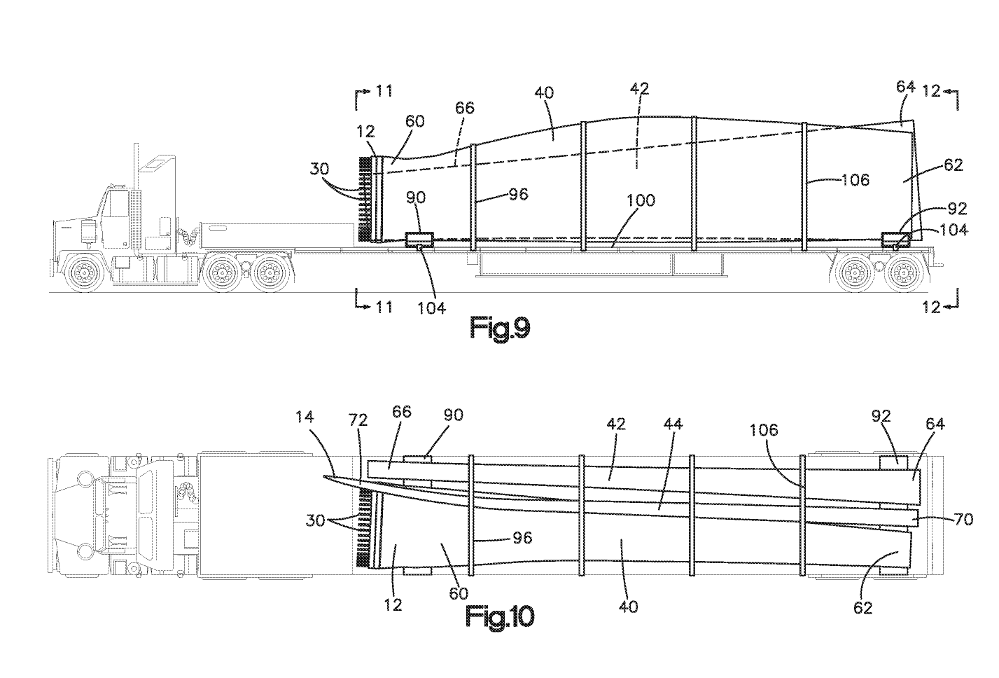

The root section 40 of the disassembled blade 10 has a circular peripheral shape at the proximal end portion 60, as shown in the end view of FIG. 3. As shown in the opposite end view of FIG. 4, the distal end portion 62 of the root section 40 has a smaller arcuate periphery at the residual leading edge 50. The other two blade sections 42 and 44 also have residual leading edges 50 with smaller arcuate peripheries at their distal end portions 66 and 72, as shown in FIGS. 5-6 and 7-8.

The illustrated embodiment further includes a pair of blade support fixtures 90 and 92. The support fixtures 90 and 92 are configured to support the separated blade sections 40, 42 and 44 on a transportation platform such as, for example, a trailer bed 100 as shown in FIGS. 9-10. The first fixture 90 is a generally rectangular block reaching across a forward end portion of the trailer bed 100. The second fixture 92 is a generally rectangular block reaching across a rear end portion of the trailer bed 100. The fixtures 90 and 92 are securely mounted on the trailer bed 100 by brackets 104 (shown schematically) or any other suitable fastening structure known in the art. A surrounding framework 106 of straps and/or rails is provided as needed.

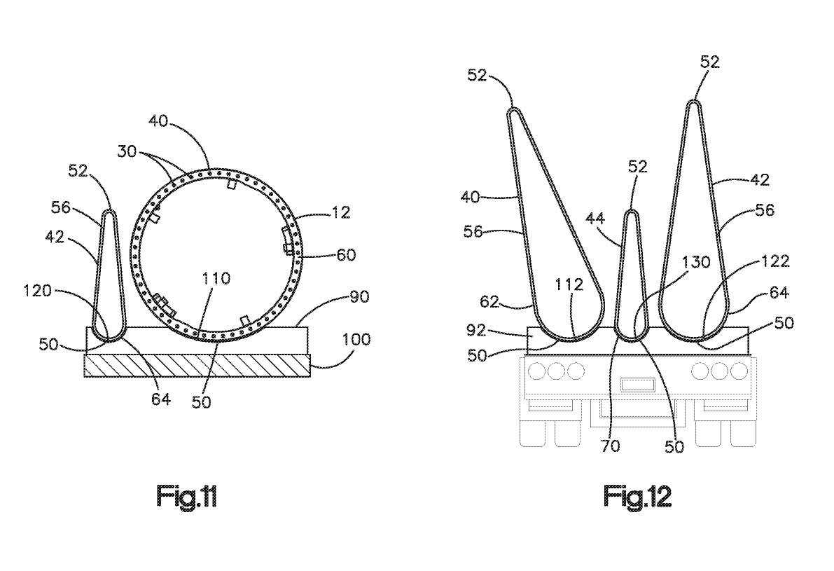

Each fixture 90 and 92 has recessed upper surfaces defining blade-receiving seats, as shown in FIGS. 1-12. Each seat has a concave contour matching the convex contour at a proximal or distal end portion of a respective one of the separated blade sections 40, 42 and 44. The fixtures are thus configured to receive and support the blade sections 40, 42 and 44 at locations spaced apart along their lengths.

For example, regarding the root section 40 of the disassembled blade 10, the first fixture 90 has a seat 110 that is contoured to match the contour of the residual leading edge 50 at a location along the proximal end portion 60 of the root section 40. The second fixture 92 also has a seat 112 configured for the root section 40. That seat 112 is contoured to match the contour of the residual leading edge 50 at a location along the distal end portion 62 of the root section 40.

Regarding the intermediate section 42 of the disassembled blade 10, the first fixture 90 has a seat 120 that is contoured to match the contour of the residual leading edge 50 at a location along the distal end portion 66. A counterpart seat 122 on the second fixture 92 is contoured to match the contour of the residual leading edge 50 at a location along the proximal end portion 64.

In the illustrated embodiment, only the second fixture 92 has a seat 130 for the tip section 44 of the disassembled blade 10. That seat 130 is contoured to match the contour of the residual leading edge 50 at a location along the proximal end portion 70 of the tip section 44. The distal end portion 72 of the tip section 44 rests on the proximal end portion 60 of the root section 40 when the three blades sections 40, 42 and 44 are secured together on the trailer bed 100, as shown in FIG. 10.

This written description sets forth the best mode of carrying out the invention, and describes the invention so as to enable a person skilled in the art to make and use the invention, by presenting examples of the elements recited in the claims. The patentable scope of the invention is defined by the claims, and may include other examples that do not differ from the literal language of the claims, as well as equivalent examples with insubstantial differences from the literal language of the claims.

1. An apparatus for use with a transportation platform, comprising:
a turbine blade in a disassembled condition defined by separated blade sections, each of which has a residual leading edge remaining from an original leading edge of the blade, a residual trailing edge remaining from an original trailing edge of the blade, and a residual length delimited by a severed edge of the blade; and
a plurality of blade support fixtures configured for mounting on the transportation platform at spaced-apart locations, wherein each fixture has blade-receiving seats configured with reference to residual edge portions of the separated blade sections.

2. An apparatus as defined in claim 1 wherein the separated blade sections include:
a root section having a proximal end portion including a root of the blade and a distal end portion ending at a severed edge of the blade;
an intermediate section having a proximal end portion beginning at a severed edge of the blade and a distal end portion ending at a severed edge of the blade; and
a tip section having a proximal end portion beginning at a severed edge of the blade and a distal end portion including a tip of the blade.

3. An apparatus as defined in claim 1 wherein the residual edge portions of the separated blade sections are residual leading edge portions.

4. An apparatus as defined in claim 1 wherein each blade-receiving seat has a concave contour matching a convex contour at a residual edge portion of a respective one of the separated blade sections.

5. An apparatus for use with a transportation platform, comprising:
a) a turbine blade in a disassembled condition defined by separated blade sections including:
a root section having a proximal end portion including a root of the blade and a distal end portion ending at a severed edge of the blade; and
a tip section having a proximal end portion beginning at a severed edge of the blade and a distal end portion including a tip of the blade;
b) a first blade support fixture configured for mounting on the transportation platform, the first blade support fixture having a blade-receiving seat configured with reference to the proximal end portion of the root section; and
c) a second blade support fixture configured for mounting on the transportation platform, the second blade support fixture having a blade-receiving seat configured with reference to the distal end portion of the root section, and further having a blade-receiving seat configured with reference to an end portion of the tip section.

6. An apparatus as defined in claim 5 wherein each separated blade section has a residual leading edge remaining from an original leading edge of the blade, and has a residual trailing edge remaining from an original trailing edge of the blade, and each blade-receiving seat is configured with reference to a residual edge of the respective end portion of a blade section.

7. An apparatus as defined in claim 6 wherein each blade-receiving seat is configured with reference to a residual leading edge at the respective end portion of a blade section.

8. An apparatus as defined in claim 6 wherein each blade-receiving seat has a concave contour matching a convex contour at the residual edge of the respective end portion of a blade section.

9. An apparatus as defined in claim 5 wherein the end portion of the tip section is the proximal end portion.

10. An apparatus as defined in claim 5 wherein the separated blade sections further include an intermediate section having a proximal end portion beginning at a severed edge of the blade and a distal end portion ending at a severed edge of the blade, and wherein the first blade support fixture has a blade-receiving seat configured with reference to one end portion of the intermediate section, and the second blade support fixture has a blade-receiving seat configured with reference to the other end portion of the intermediate section.

11. An apparatus for use with a transportation platform and a turbine blade in a disassembled condition defined by separated blade sections, each of which has a residual leading edge remaining from an original leading edge of the blade, a residual trailing edge remaining from an original trailing edge of the blade, and a residual length delimited by a severed edge of the blade, the apparatus comprising;
a plurality of blade support fixtures configured for mounting on the transportation platform at spaced-apart locations, wherein each fixture has blade-receiving seats configured with reference to residual edge portions of the separated blade sections.

12. An apparatus as defined in claim 11 wherein each fixture has blade-receiving seats configured with reference to residual leading edge portions of the separated blade sections.

13. An apparatus as defined in claim 11 wherein each blade-receiving seat has a concave contour matching a convex contour at a residual edge portion of a respective one of the separated blade sections.

14. An apparatus for use with a transportation platform and a turbine blade in a disassembled condition defined by separated blade sections, each of which has a residual leading edge remaining from an original leading edge of the blade, a residual trailing edge remaining from an original trailing edge of the blade, and a residual length delimited by a severed edge of the blade, the apparatus comprising:
a blade support fixture configured for mounting on the transportation platform, wherein the fixture has a blade-receiving seat configured with reference to a residual edge portion of a separated blade section.

15. An apparatus as defined in claim 14 wherein the blade-receiving seat is configured with reference to a residual leading edge portion of the separated blade section.

16. An apparatus as defined in claim 14 wherein the blade-receiving seat has a concave contour matching a convex contour at a residual edge portion of the separated blade section.

17. An apparatus as defined in claim 16 wherein the concave contour is circular.

18. An apparatus as defined in claim 16 wherein the concave contour matches a convex airfoil contour at a leading edge of the separated blade section.
